(19) United States
(12) Patent Application Publication
(10) Pub. No.: US 2015/0326522 A1
(43) Pub. Date: Nov. 12, 2015

(54) System and Methods for Event-Defined and User Controlled Interaction Channel

(71) Applicants: Ninghua Albert Pu, Walnut, CA (US); Shirong Wang, Walnut, CA (US)

(72) Inventors: Ninghua Albert Pu, Walnut, CA (US); Shirong Wang, Walnut, CA (US)

(73) Assignees: Shirong Wang, Walnut, CA (US); Ninghua Albert Pu, Walnut, CA (US)

(21) Appl. No.: 14/703,879

(22) Filed: May 4, 2015

Related U.S. Application Data
(60) Provisional application No. 61/989,356, filed on May 6, 2014.

(51) Int. Cl. H04L 12/58; G06F 21/62; G06Q 50/00

(52) U.S. Cl. CPC H04L 51/32; H04L 51/12; H04L 51/16; G06Q 50/01; G06F 21/6245

(57) ABSTRACT

System and methods for an event defined and user controlled interaction channel are disclosed. The interaction channel can be added to people, locations, things, or media content for associated activity and information interactions between interested parties to achieve a goal or outcome. The disclosed system may include mobile, web, and cloud applications or services supporting enablement of an interaction channel for attachment and/or interconnection with traditional or social media sources, communication services, or other referenced objects to facilitate added layers of host-defined and user controlled interactions. The methods may include an event definition process for an event host to easily and quickly attach an interaction channel to a referenced object for user controlled interactions. The methods may also include convenient and non-intrusive event sign-in or channel connection processes for users to have full control of how they want to participate and control their data privacy in activity and information interactions with the event-defined interaction channel host and/or users.

### CROSS REFERENCE TO RELATED APPLICATIONS

This application claims priority to U.S. Provisional Patent Application No. 61/989,356, filed on May 6, 2014 on behalf of Pu et al., the disclosure of which is incorporated herein by reference in its entirety.

### FIELD OF THE INVENTION

The present disclosure relates generally to providing an interaction channel for user controlled and event defined activity and information interactions in reference to one or multiple physical, mental, digital, social, or organizational objects through the use of mobile, social, and cloud technologies.

### BACKGROUND OF THE INVENTION

Information exchanges between people and especially from business or organizational entities to consumers leverage media sources electronically or physically as one of the main mechanisms. People interact with media sources such as billboards, newspaper, TV, websites, or social media for information gathering or exchanges. Social media platforms such as Facebook, Twitter, or Yelp typically goes a step further with instantaneous and user-generated information interactions at a much granular and fine-controlled levels for the producers and consumers of the information. Email, messaging or communication services such as SMS, WhatsApp or WeChat are frequently used by people also for spontaneous message or information exchanges. However, information exchanges with media, email, or messaging platforms are usually informational, random, spontaneous, or unorganized.

Interactions between people supporting a common purpose that produces outcomes normally requires an organizer, one or multiple mechanisms of supporting information exchange between people, and often times one or multiple group activities, system or device functions, or process rules. These interactions are usually grouped under an event, a project, with a party, a task force, or other grouping mechanisms that are carried forward either manually, physically, or digitally by the engaged participants.

There are many computer based applications supporting information exchange or event or group level interactions between people with varied features and functionalities. Popular social network sites such as Facebook, Twitter, or Google+ support event or social gathering related communications or group activities. However, they do not handle complex group activities or functions with processing rules. They also have has limited privacy that all user generated communication or activity data are visible or traceable to a third party, and often times the data are the properties of the social network. Additionally, it requires a user account on the same social network to sign into and participate, which is not always applicable to all people intending in joining.

Business entities such as a national merchant or wholesale warehouse may also have applications supporting a promotional and customer connection events. However, they are typically part of their overall business entity application such as a promotional event on a merchant's website or mobile app. The app may also provide some transactional features in support of a user to engage in a sales promotional event. However, these promotional or customer connection events are usually spread across multiple business entity based apps, which usually very hard to track due to the many applications on a user's device and sales promotional event are usually one of the many features of an entity based app. Additionally, promotional or customer connection event embedded in business entity apps usually do not offer user controls of participation mode and data privacy settings. It also does not offer the flexibility and ease of use for fine-grained control by the actual business associates involved in these promotional or customer connection events to easily create or adapt the information to the customers.

There are also social or organizational event specific applications that are tailored to specific personal, social, or business settings for organizing and facilitating information exchanges between people. These applications are developed specifically for a certain venue, industry, task or event type such as conferences, trade shows, wedding planning, matchmaking, and etc. However, these organized and topic specific applications are usually controlled by event host and do not allow much flexibility of user control of their participation mode and personal data privacy.

There are multiple drawbacks with the current applications supporting purpose or outcome driven information exchanges and user activity or function interactions. One of the major drawbacks is lack of or limited support for user controlled data privacy and participation setting, which is prevalent in communications or user activities via social network sites or messaging tools. In these scenarios, user's geographic and demographic data are tracked and analyzed for targeted advertisement. Another major drawback is the current applications in user communications are inflexible in supporting a variety of purpose-driven user information exchange scenarios that may have complex functions and user interaction logics. There is also not an easy and simple mechanism for a person to quickly create and attach an interaction channel to something that the person would like to discuss with the potential interested parties and also in a non-intrusive way to the participants.

### SUMMARY OF THE INVENTION

This invention is in response to the current challenges in the purpose and outcome driven information exchange and user activity or system function interactions. The invention discloses a system and the related methods for using an event to group multiple information entities and user interaction activities or functions together for purpose and outcome driven information exchange and user interactions. The disclosure supports organizer self-definition and management of event described herein, as well as user self-control of user profile selection or creation for event and/or event activity participation, user self-control of user data privacy and data sharing, user data persistence and retention settings, and user self-control of event participation mode and activity participation management. Additionally, the disclosure provides a secured and user controlled interaction channel for individuals or business entities to quickly and easily configure and add on to extend activities and communication about one or multiple people, locations, organizations, entities, establishments, tasks, goals, physical events, or content on digital or non-digital information or media sources.

In certain embodiment, the disclosed system includes a client-side application for event hosts and users, managed and facilitated by an event and interaction management service, to connect with a plurality of social network sites or web sites for event related information exchange and/or sharing. The client-side computer application is used for a host to define and manage an event, as well as for the client-side application users to pull in an event for user controlled event participation with user self-control of their participation profile, participation mode, and user data privacy and persistence controls.

Certain embodiments of the present invention provide a method for an event host to quickly define an event by choosing a system provided template with default user participation mode and data privacy control settings. The method also enables the host to custom define an event with fine-grained controls for event default user participation mode and user data privacy setting, as well as adding complex business logic and rules for personalized event activity and user controls related to user profile characteristics, and user provided sign-in and/or event sign-up information.

Certain embodiments of the present invention provide a method for a user to quickly join an event by pulling in an event into the client-side application based on an event id or via a click through link, by taking the default profile setting and preferences as pre-defined by the user in the event app user preference setting. The method also provides the user with fine-grained controls for user sign-in profile, participation mode, event activities, and user data privacy and event server persistence preferences.

Certain embodiments of the present invention provide a method for user event participation via the application that a user can participate in common event activities with total control of user data privacy, sign-in profile preference. Additionally, depending on the provisioned event setup for additional user controls, the user can also customize their participation mode for the event or one or multiple event activities.

### BRIEF DESCRIPTION OF DRAWINGS

The present invention will be more fully appreciated by the following detailed description in conjunction with the accompanying drawings, wherein:

FIG. 1 is a diagram of an example environment in which the system and/or the methods described herein may be implemented;

FIG. 2 is a diagram of an example interaction between event users and/or host with an event and the event components;

FIG. 3 is a functional block diagram illustrating an example of the functional components of the server-side event and interaction management service in the cloud shown in FIG. 1;

FIG. 4 is a functional block diagram illustrating an example of the functional components of the client-side computer application running on host and user computer devices shown in FIG. 1;

FIG. 5 is a flow chart showing an example of a process that may be performed by an event host in defining an event;

FIG. 6 is a flow chart showing an example of a process that may be performed by a client-side application user to discover, sign in or sign up for an event via a simple and quick path, as well as via a more elaborate path if the user choose to customize sign-in profile, participation modes, and data privacy settings;

FIG. 7 is a flow chart showing an example of a process that may be performed by a client-side application user during event participation with user-controlled data and user privacy settings.

### DETAILED DESCRIPTION

Operation of the invention may be described with reference to the following example embodiments. One embodiment applies to, among many other things, the situation where personal and commercial ad or promotional event in a media source can be easily extended with an add-on user communication channel for user self-controlled information exchanges with interested parties. In this situation, upon placing the ad or promotional event content in a media source, the advertiser or organizer can act as an event host by quickly defining an event as an add-on interaction channel in the said system with interested parties for information exchange such as describing additional details to the ad or promotional event, responding to user inquiries, or follow-ups in a host-defined and user-controlled participation manner. Interested parties can pull in the event via the client-side application disclosed in the invention, choose to participate in the event with a user-define profile of any type or anonymously, and start communicate with the host for the interest ad or promotion as they see in the media source. In this way, the user is not concerned about giving out email addresses or phone numbers and can control when or whether to reveal his or her identity during the event. Additionally, event users can also control how they would like their user-generated data, such as their messages to host or activities conducted during the event participation, be stored or removed on the server or the correspondent's client devices.

Other embodiment applies to, among many other things, business entities connecting and growing customer base with personalized interactions with their customers or prospects without knowing customer email or social network account information. As disclosed by the present invention, a merchant can define a “customer connection” event quickly in the disclosed event app, and post the event barcode, QR code or id physically or in a media source. The merchant can announce special, menus, or tailor offers as event information items or activities. Their customers or prospects can pull in the event to the disclosed event app to learn about specials, offers or personalized discounts, and participation in a merchant's loyal customer program for additional incentives. The benefit of viewing and participating merchant customer connection event disclosed in this invention is not only a quick and easy interaction channel with a merchant for information or incentives, but also user self-control of data privacy without giving out user personal information.

Other embodiment applies to bar or party goers can extend their physical presence in better reaching out and getting connected with other party goers, instead of relying on first impression from a distance or via introduction via a mutual contact. In applying the present invention, the bar host can define a recurring event for “meet-up” that these party goers can choose to sign-in with their self-defined and/or preferred profile or anonymously, choose to share their profile to the event, browse event user profile directory for possible people profile characteristics and request for meet up. The user would not be concerned about activities or message exchanges during the event due to the event data comes and goes after the event expires.

Other embodiment applies to, among many other things, membership growth and communications where activities and communications between host and users can be grouped and defined as an event (such as a political campaign or interest party in discussing a particular topic). User can sign into an event with their self-defined and preferred profile or anonymously, where they can view, exchanges opinions with the host and/or define a special group, as well as share viewpoints outside of the event ecosystem to others as or if allowed by the event host. All their activities are contained with the event ecosystem and comes and goes with the event expires.

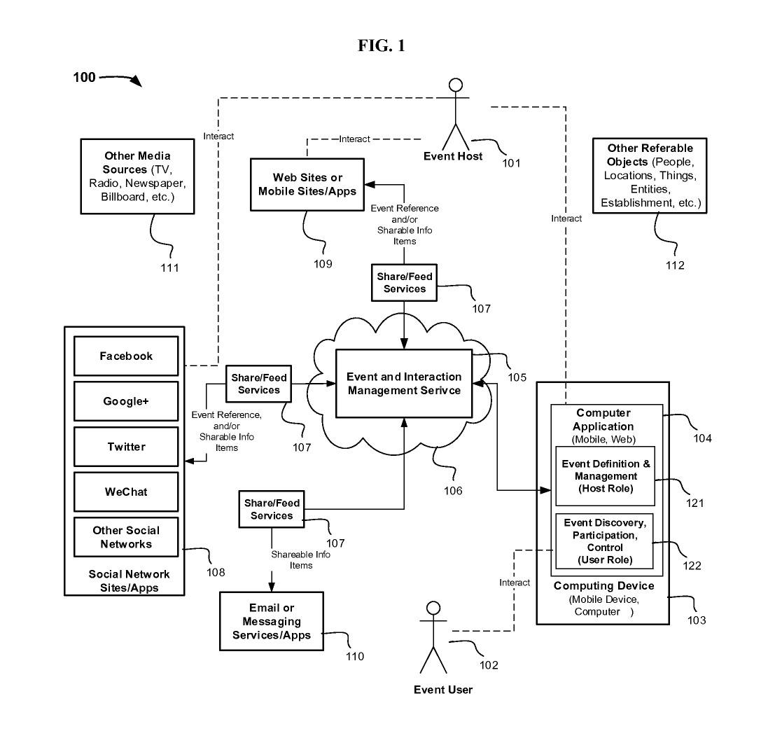

FIG. 1 is a diagram of an example environment 100, in which the system and/or the methods described herein may be implemented. As illustrated, environment 100 may include event host 101 and event users 102 interacting with a client-side computer application 104 running on a computing device 103, an event and interaction management service 105 running in a cloud 106, share and feed services 107 that event host or users can use to pull or push event related information items from or to other social network sites and apps 108, web or mobile sites and apps 109, email or message services or apps 110, other digital and physical media sources 111 and/or other referable objects such as people, things, locations, entities, needs, social or business activities that the event can reference and be added on as an user-controlled interaction channel.

Event host 101 maps to an event host role in the said system that defines and manages the event and event users, perform host event actions and other event administrative activities. The event host can be a person, group of people, a business entity, an organization, or any other social, organizational, or legal entities, their designees or delegates.

Event users 102 map to a user role that participates in an event and performs event defined activity and inform interactions. The event host may also act in the event user role when acting as an event user in participating in event defined activity and inform interactions. An event user can also be a person, group of people, a business entity, an organization, or any other social, organizational, or legal entities, their designees or delegates.

Computer application 104 may be a web or mobile application that interfaces with the event and interaction management service 105 for event definition and management 121 by event host 101 and event discovery, participation, and control 122 by event users 102.

Share and feed services 107 are used by an event host to push or pull event definition from a social or web site. It may also be used by the event host or users to push or pull event activities or communications, if provisioned for the event user by the event participation control defined by the host, to other social, web, and/or email or message clients. Share and feed services 107 can be APIs, interface services or other computer program implementations provided by the said system, social network sites, mobile apps, a third party service, and/or via email or messaging services.

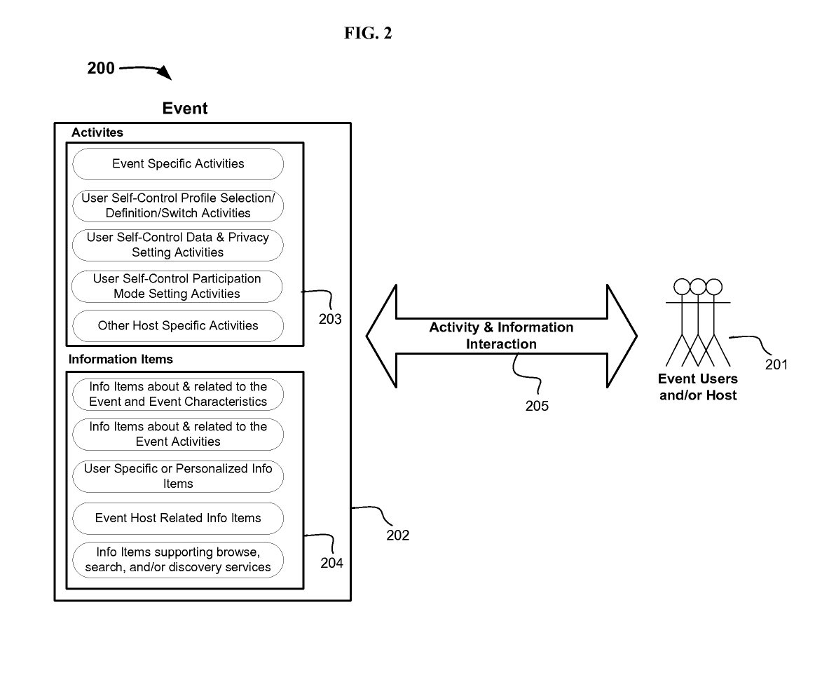

FIG. 2 is a diagram of an example interaction environment 200 between event users and/or host with an event and the event components. As illustrated, an event 202 is comprised of activities 203 and information items 204. Event host or users 201 conduct activity and information interactions 205 with the event 202.

Event 202 is used to define and organize a singular and/or a collection of varied sequential and/or simultaneous activities and information items that has one or multiple purposes and/or produces one or multiple outcomes. An event requires more than one person's participation and has a duration that can be repeating, short or long-running. An event can be pertaining to one or multiple people, things, locations, organizations, entities, establishments, tasks, goals, physical events, or content on digital or non-digital information or media sources. An event can be linked to or occur within another event. An event has a lifecycle that may have one or many stages as determined by the event host, event progression status such as pre-event, event sign-up period, event in progress, or any other event progression period determined by the event characteristics.

An activity, as part of the event-defined activities 203, is a collection of one or multiple functions, processes, actions, transactions, and/or communications accompanied by the related information items that an event user can interact with or invoke. An activity interaction by an event user will result in a status or state changes and/or one or multiple system responses. An activity has duration and can be defined with business logic, business rules, and/or user invocation requirements. An activity can also be part of another activity or related to one or many other activities, provisioned to all the event users or a select group of event users based on user profile characteristics, user sign-in or sign-up controls or information, relationship to other activity or activities, and/or associated with the entire event or one or multiple event lifecycle stages.

Activities 203 defined in an event 202 may have event specific activities that are related to the event purpose or type, user self-control activities that may be related to user profile selection, definition, or switch activities, data and privacy setting activities, and participation mode setting activities, as well as host specific activities.

Information items 204 defined in an event 202 are related to or describe events, event activities, event host and users, and/or event association supporting search, browse, or discovery via location, topic, or establishment aware services.

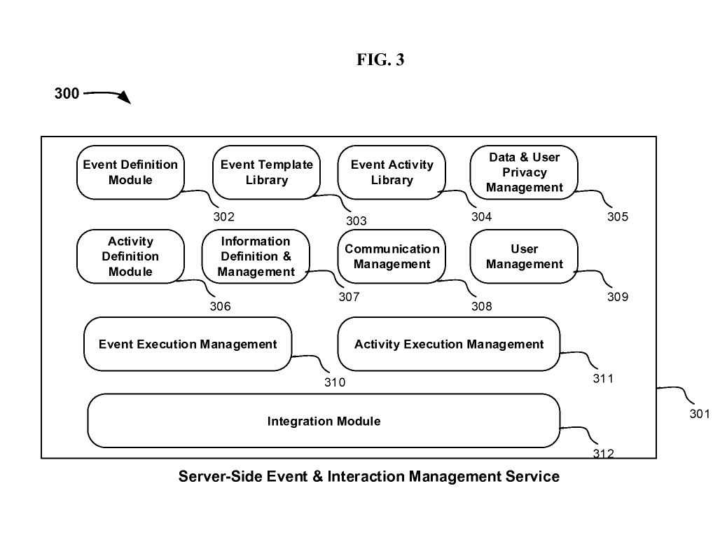

FIG. 3 is a functional block diagram illustrating an example of the functional components of the event and interaction management service running in cloud as shown in FIG. 1. The event and interaction management service 301 may include event definition module 302, event template library 303, event activity library 304, data and user privacy management 305, activity definition module 306, information definition and management 307, communication management 308, user management 309, event execution management 310, activity execution management 311, and integration module 312.

Event definition module 302 is used by a host to define an event or invite users to participate the defined event. A host can define an event that groups activities and/or information items via a blank or predefined event template in the event template library based on event purpose or categorization. An event may be defined by referencing content, with share and feed services, to digital information or media sources such as an ad, promotional event, or party announcement on a website, online newspaper, social network site, or via a mobile app. An event may also be defined, without share and feed services, by referencing one or multiple physical, mental, digital, social, or organizational objects, as an add-on user-controlled interaction channel.

A host can quickly and easily create an event-defined interaction channel by clicking through a chosen event template and filling in the required information. A host can also custom define an event with fine grained controls and custom settings for additional event information items, activities, user participation mode, user data privacy, and/or user data persistence and retention settings.

Event template library 303 is consisted of system predefined event creation templates that can be applied and customized by an event host. These templates are tailored to different event purposes or categorization such as restaurant customer connect, pet store customer connect, an sales item connect with potential buyers, a weekend party connect with participants, a neighborhood watch connection with neighbors, and many others. Each event creation template is predefined with default event purpose and/or categorization related event specific activities, user self-control profile selection, definition, or switch activities, user self-control data and privacy setting activities, and user self-control participation mode setting activities. Each template is also predefined with default event purpose and/or categorization related event and event activity specific information items and default information items supporting browse, search, and/or discovery services.

Event activity library 304 consists of system predefined activities that are common and reusable activities across different event types and/or categorizations. Each activity may be associated with user self-controls for data privacy, data sharing, data persistence and retention settings, and/or participation mode settings.

Data and user privacy management 305 is used for management and execution of host and/or user defined user generated data and user privacy controls related to user profile selection or creation for event and/or event activity participation, user data privacy and data sharing, user data persistence and retention settings, and event participation mode and activity participation management. An event user can define more restrictive data and user privacy settings than ones defined by the event host for the event. In this case, the user defined more restrictive settings will take precedence for security and privacy control of user-generated data.

Activity definition module 306 is used by a host and/or users to define a new activity that are not part of the event template or is not available in the event activity library, or to customize an existing activity with modified or additional business logic, rules, and/or user invocation requirements. An event user can also define a new activity for the event, if provisioned by the event host.

Information definition and management 307 is for event and event activities related information items creation, management, and processing during event definition and event processing and execution phases.

Communication management 308 is used for management of data or information items exchange, creation, and consumption by event host and event users during the execution of an event.

Activity execution management 309 is used for management of activities and activity lifecycles, and execution of activity related business logic, business rules and/or activity execution requirements pertaining to an event, host, and event users.

Event execution management 310 interoperates with communication management 308 and activity execution management 309 for event execution and event lifecycle management related to all the event-defined and related activity and information interactions between event users and/or host, including execution of related business rules, process definitions, user provisioning controls, and personalization logics for activities or information interactions for the event.

User management 311 is used for event host to perform administration tasks for event users and event user interactions during execution of an event.

Integration module 312 is used for connectivity and interfaces between the server-side event and interaction management application service modules and the client-side computer application modules running on host and user computing devices, including the associated functions, transactions, process handling, communications, and data and/or activities exchanges within the said system.

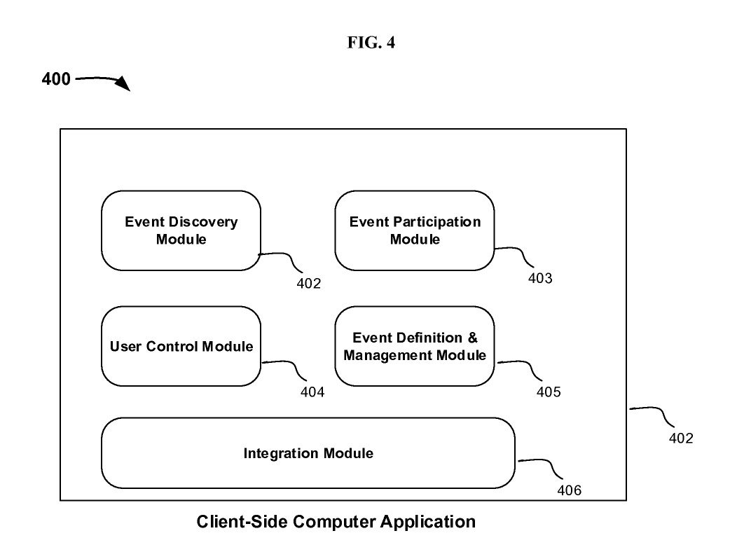

FIG. 4 is a functional block diagram illustrating an example of the functional components of the client-side computer application running on computer devices shown in FIG. 1. The client side computer application may include event discovery module 402, event participation module 403, user control module 404, event definition and management module 405, and integration module 406.

Event discovery module 402 is used by a client-side application user to search, browse, and discover one or multiple events to participate with an associated user profile or anonymously, as well as with the associated user controlled participation mode and data settings. It interfaces with the server-side event and interaction management service 301 and mainly with the execution management module 302 for search, browse and discovery of the available and applicable events running in the disclosed system.

Event participation module 403 interfaces with the event and interaction management application service 301 across multiple modules on the server side. It is use by the event users to perform event and event activity participation at all levels as controlled by the event associated user self-control settings such as the associated participation mode setting and user data privacy, data sharing, data persistence, and data retention settings. These user self-control settings are fulfilled by the user control module within the client-side computer application and may be invoked from within an event for a user to configure or change the event specific user self-control settings.

The event participation levels and the associated participation mode may be related with a user's interest in passively or actively following or viewing the event or event activity information, or a user's interest in sign-up, sign-in, sign-out, and/or interacting with an event or event activity with varied degrees of information exchanges.

User control module 404 is integrated with the server-side event and management application service 301 and mainly with the server-side user management module 309 for system wide user management and control executions. It may be used by a client-side application user to perform user self-control of event and/or event activity profile selection or creation, user self-control of user data privacy and data sharing, user data persistence and retention settings, user self-control of event participation mode and event activity participation management.

The user control module 404 may also be used by a client-side application user to perform user preference settings for default event and/or activity participation profile, default user data privacy and data sharing settings, default user data persistence and retention settings, default user participation mode setting across all events if the user does not specify additional user self-control settings. Additionally, it may be used to configure a user's preference for the default display and notification settings for multiple events when participated at the same time.

When a user wants to create, host, and/or manage their own event, the event participating user can also use the user control module 404 to switch between user or host roles to host an event-defined interaction channel pertaining the user.

Settings for the user self-control data privacy and data sharing, data persistence and retention, and participation mode can override the host event settings for user generated data if the user settings have more restrictive data and user privacy controls. These user preferences settings for data privacy and data sharing, data persistence and retention can be associated with the client-side application as default for all the events a user may choose to participate, or the user preference data and user privacy settings can be associated with one or multiple user profiles defined by the users in the client-side application.

Event definition and management module 405 interfaces with the server-side event and management application service 301 and mainly with the server-side event definition module 302, event template library 303, event activity library 304, and activity definition module 305. It serves as the user interface layer for the event and interaction management service for use by an event host to create event-defined and user controlled activity and information interactions channel, which may reference one or multiple physical, mental, digital, social, or organizational objects. The event definition and management module 405 is also used by an event host to manage users, perform host event actions and other event administrative activities.

Integration module 406 is used for client-side application interactions and data exchanges with the server-side event and management application service interfaces 301, 3rd party share and feed services inside a client-side computing device, and/or 3rd party software, infrastructure or cloud services that might be related or applicable to an event-defined activities or information items.

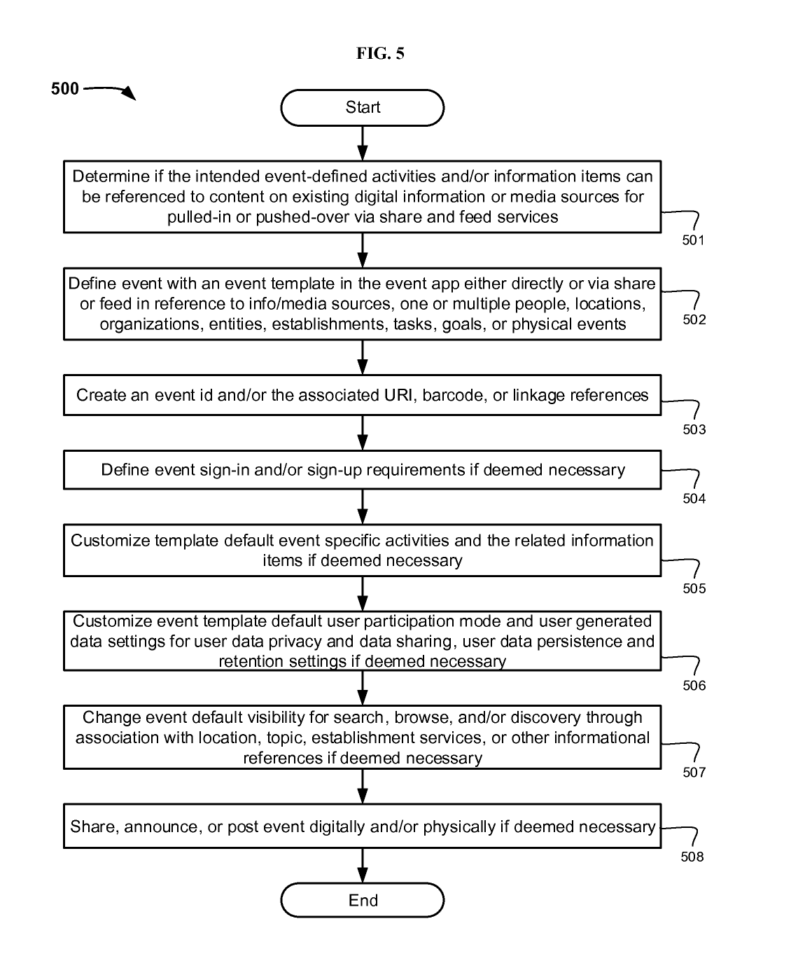

FIG. 5 is a flow chart 500 showing an example of a process that may be performed by an event host in defining an event. To create an event that is used for activity and information interactions between host and the said client computer application users, a host first determines if the intended event-defined activities or information items can be referenced to content on existing digital information or media sources and if the related content can also be pulled in or pushed over via share and feed services 107 as in the example environment 100 (block 501). Digital information or media sources are social network sites, web sites, mobile apps, or media sources such as online newspapers, digital version for a magazine or publication. The host then defines the event with an event template in the event app either directly or via share or feed in reference to information or media sources, one or multiple people, locations, organizations, entities, establishments, tasks, goals, physical events (block 502). To complete a simple event definition, the host will need to create an event id, which can be created manually or generated automatically by the said system (block 503). If necessary and applicable, the event associated URI, barcode, QR code, or linkage references will also be created (block 503).

In process block 502, the event can be defined via share or feedback services in reference to content already exist in another information or media source. The event can also be defined in reference to content in digital or physical information or media sources without using share or feedback services. In this situation, the event is defined directly in the event application, which can be in reference to one or multiple people, locations, organizations, entities, establishments, tasks, goals, physical events, or content on digital or non-digital information or media sources.

When defining an event in the event application, a host starts from selecting an event template from the event template library based on the intended event purpose or categorization. The selected event template can be a blank event definition template or a pre-configured event template for a specific event purpose or categorization such as a “hobby store customer connection event” or “newspaper personal ad add-on channel”. The event template is set up with pre-defined activities and information items pertaining to the event purpose or categorization, default user settings for event and/or event activity participation mode, user data privacy and data sharing, and user data persistence and retention settings.

The host then chooses or applies the event template default activities, information items, and user controllable event settings for user generated data by populating the information items that are related or describe the event, event activities, event host and users, and/or event association supporting search, browse, or discovery via location, topic, or establishment aware services.

Process blocks 504 to 508 are more complex event definition scenarios where an event host choose to define event sign-in or sign-up requirements (block 504), customize template default event specific activities and the related information items (block 505), customize event template default user participation mode and user generated data settings for user data privacy and data sharing, user data persistence and retention settings (block 506), change event default visibility for search, browse, and/or discovery through association with location, topic, or establishment services (block 507), or share, announce, or post event digitally or physically (block 508).

In process block 504, a host can choose to define event sign-in or sign-up requirements for event users if applicable. Event sign-in and/or sign-up requirements are additional information such as an invitation number or VIP code, verification code such as a ticket or purchase transaction number, authentication or authorization information that an event user needs to enter to sign in or sign up for the event. Event sign-in or sign-up requirements are associated with information items, business logic, business rules, or personalization rules for personalized or targeted event information presentment.

In process block 504, a host can also choose to personalize event information presentation to event users by defining event information personalization rules for personalized or targeted event information presentment. Event information presentment personalization rules can be associated with the user provided sign-in or sign-up information, verification code, authentication or authorization information, or user profile characteristics. For example, an event host can define personalization rules associated with user provided sign-in information from their invitation code categories. In a promotional event scenario, users signing in with a VIP invitation code will be presented with a better promotion upon sign-in.

In process block 505, a host can choose to customize template default event specific activities and the related information items. A host can add one or multiple activities from the activity library, remove one or multiple activities from the event template, modify one or multiple activities pre-defined in the event template with the activity definition module via the event application, define one or multiple new activities with the activity definition module via the event application, determine whether to provision one or multiple activities in event to specific event users, or provision activities to specific event users by defining activity provisioning rules based on user profile information, user profile characteristics, or user provided sign-in or sign up information.

In process block 506, a host can choose to customize event template default user participation mode and user generated data settings for user data privacy and data sharing, user data persistence and retention settings. User event participation mode is event defined activity and information interaction settings related to online, offline, and/or event directory visibility, incoming and outgoing communication preferences between host and/or other event users related to event or activity message type, frequency or notification preference, user settings for silencing, blocking, or alarming on incoming user requests and/o participation level based on activity, activity type, or activity or user characteristics.

For event template default user participation mode, the host can customize the event default participation mode if choose to. Event participation mode is event defined activity and information interaction settings related to online, offline, and/or event directory visibility, incoming and outgoing communication preferences from or to host and other users related to event or activity related message volume, frequency or notification preference, user settings for silencing, blocking, or alarming on incoming notifications, messages, or user request for actions based on types and related activities, and participation style related to activity level.

The host, if choose to, can also customize event default data privacy and data sharing setting for user generated data produced during event defined activity and information interactions. Data privacy and data sharing setting is specifications and controls for user generated data visibility and visibility levels, data collection and dissemination privileges and availability to the event host, other event users, and/or third party users, and the data privacy and sharing setting can be associated with the entire event lifecycle, one or multiple event lifecycle stages, an event activity, one or multiple event-defined activity or information interactions, or a user profile or profile switch action.

The host, if choose to, can also customize event default data persistence setting for user generated data produced during event defined activity and information interactions. Data persistence setting is specifications and controls for user generated data persistence location and saving or archiving privileges and availability to the event host, other event users, and/or third party users, wherein persistence and/or data saving location is the server side and client-ends locations that the user generated data traverses, includes the computing device used by the event user for data generation, the event and interaction manager service server-side location that may process the user data, and the computing devices used by one or multiple correspondent event users. Data persistence setting can be associated with the entire event lifecycle, one or multiple event lifecycle stages, an event activity, one or multiple event-defined activity or information interactions, or a user profile or profile switch action.

The host, if choose to, can also customize event default data retention setting for user generated data produced during a user's event defined activity and information interactions. Event default data retention setting is specifications and controls for user generated data expiration settings for the persistence and/or cache locations that the user data may traverse so that the data will no longer be available at the specified locations according to data expiration settings. The data retention setting can be an absolute or relative duration value associated with the entire event lifecycle, one or multiple event lifecycle stages, an event activity, one or multiple event-defined activity or information interactions, or a user profile or profile switch action.

In process block 507, a host can choose to change event default visibility for search, browse, and/or discovery through association with location, topic, or establishment services. During event definition, a host can choose to change event template default search or browse categories, types, keywords, tags, venue-related information, and/or other characteristics that can be used for browsing and searching. A host can also choose to change event association with a location or location attributes, an entity or establishment, and/or a topic or information categorization so that the event can be discovered via location services or attributes, interest in an entity or establishment, and/or interest in a topic or information categorization. Additionally, a host can choose to change event target user attributes, user profile characteristics, requirement attributes that can be mapped to user sign-in and/or sign-up information.

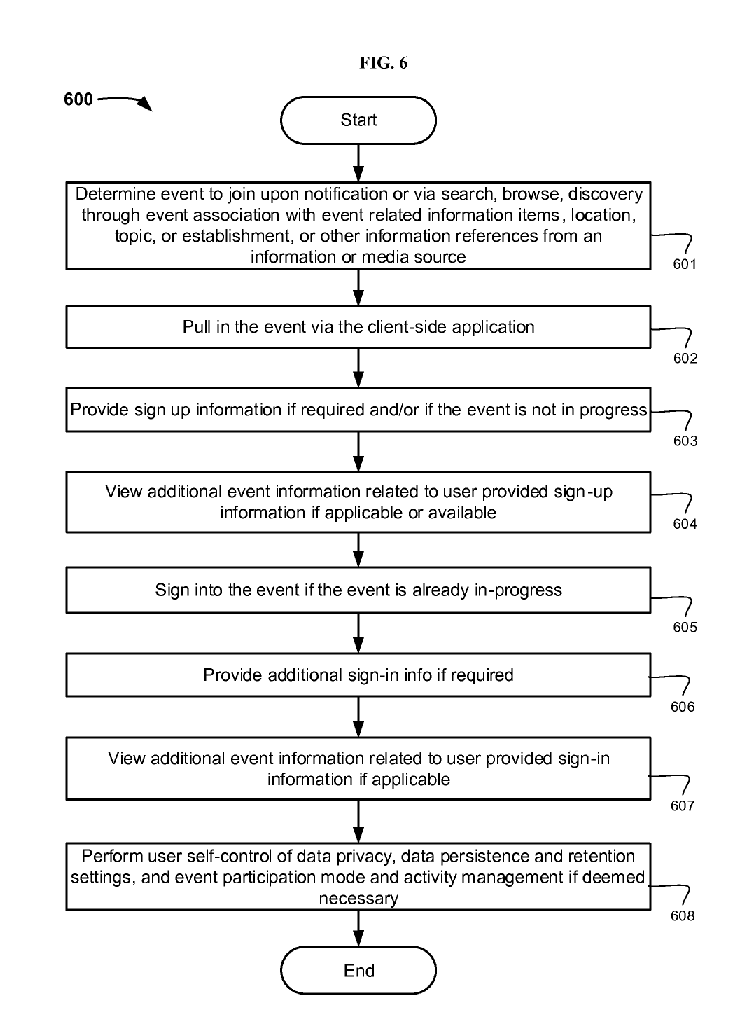

FIG. 6 is a flow chart showing an example of a process 600 that may be performed by an client-side application user to discover, sign in or sign up for an event via a simple and quick path, or via a complex path if the user interested event requires additional sign-up or sign-in information, or if the user choose to customize sign-in profile, participation modes, and data privacy settings.

To join an event defined in the present invention via a simple and quick path, the user first determines, via the client application discovery module 307 as in the example functional block 300, an event to join upon notification or via search, browse, or discovery through event association with a location, topic, or establishment, or from an information or media source (block 601). After identified an event to join, the user then pulls in the event via the client-side computer application (block 602) to start event participation if the event is not setup with sign in or sign up requirement or if the user does not want to customize the event participation mode or user privacy and data settings.

In process block 601 where a user determines an event to join, the user can learn about an event via notification such as email or message notification or a post on a wall. The user can also learn about an event via information gathered from media such as newspaper, web media, social media, or from a billboard. Additionally, user can determine an event to join via search or browse in the client side computer application with keywords, tags, or category browsing. The user can also discover an event via location services or an event association with a topic or an establishment such as a shopping center, a plaza, or an organization.

In process block 602 where a user joins an event by pulling in the event via the client-side application, there are several options for the user to pull in the event to participate. The user can pull in the event via entering an event id as from the information the user found from a newspaper or website. The user can also pull an event into the said application via scanning an event barcode or QR code. The event barcode or QR code can be on a social network or web site or their associated mobile app, included in an email or message via an email or messaging service, or the barcode or QR code can be on a sticker or posted on the wall. Additionally, a user can join an event by following or clicking on a URI or reference link associated with the event that will bring up the event in the said application, wherein the URI or reference link can be on a social media site, website, inside a mobile app, included in an email or message, or from a traditional medial such as newspaper, TV, or billboard. A user can also click on the event icon in the event app identified via browse, search, or discovery via an event association with a location, topic or establishment aware services.

After pulling in the event in the said application, a user can either participate in the event or the user may be required to provide event sign up information if required by the event host or if the event is not in progress (block 603). The event sign up information can be a code provided to a user via an invitation, a string that can be used to identify a user or an authorization mechanism such as an access token or role matching to profile characteristics for fine-grained access control.

After providing the event signup information and signed up for the event, the user may have views to additional event information related to user sign-up information (block 604). The sign-up related event information is additional information items and categories that can be presented generically and/or personalized after user sign-up information (like an additional discount). A user can also sign into the event by selecting an existing user profile, defining a new user profile, or signing into the event anonymously (block 605).

A user can also provide additional sign-in info if required (block 606) to be authorized to participate in the event. The additional sign-in information can be a code or reference id associated with a sales transaction, an order, a business transaction or commitment, and/or a verification mechanism such as a sign-in token or authentication and/or authorization requirement. If applicable, a user may view additional event information related to user provided sign-in information (block 607). The applicable sign-in related event information are additional information items and categories that can be presented generically and/or personalized after user sign-in information.

Event hosted by the present invention has event template default or host customized settings for user data privacy, data persistence and retention settings, and default user participation mode. The event template default or host defined user and data privacy related settings can be override by an event user if the event user preferred data and user privacy have more strict settings than the default ones.

After signed in to an event, a user can determine need for user self-control and change the event default data privacy and data sharing, data persistence and retention settings, and event participation mode and activity management (block 608). For self-control of data privacy and data sharing settings, an event user can configure data privacy and sharing preference for user generated data, which is specifications and controls for user generated data visibility and visibility levels, data collection and dissemination privileges and availability to the event host, other event users, and/or third party users. Data privacy and sharing setting can be associated with the entire event lifecycle, one or multiple event lifecycle stages, an event activity, one or multiple event-defined activity or information interactions, or a user profile or profile switch action.

User data persistence and retention settings are related to user generated data persistence location and retention during relative to an activity during and/or after event lifecycle. An event user can choose to customize the event default setting and specify if he or she wanted the user generated data to be persisted on local client only, on the server-side as well, or also on the correspondent's user's client devices. User data persistence setting is specifications and controls for user generated data persistence location and saving or archiving privileges and availability to the event host, other event users, and/or third party users. User data persistence and/or data saving location is the server side and client-ends locations that the user generated data traverses, includes the computing device used by the event user for data generation, the event and interaction manager service server-side location that may process the user data, and the computing devices used by one or multiple correspondent event users. User data persistence setting can be associated with the entire event lifecycle, one or multiple event lifecycle stages, an event activity, one or multiple event-defined activity or information interactions, or a user profile or profile switch action

An event user can also override and configure how long the user want to have the data retained on the server or on their client device related to the interaction activities such as retain data for 10 minutes, 1 day, or immediately after the event is completed or user decides to exit from the event permanently. User data retention setting is specifications and controls for user generated data expiration settings for the persistence and/or cache locations that the user data may traverse so that the data will no longer be available at the specified locations according to data expiration settings. The data retention setting can be an absolute or relative duration value associated with the entire event lifecycle, one or multiple event lifecycle stages, an event activity, one or multiple event-defined activity or information interactions, or a user profile or profile switch action.

User participation mode is event defined activity and information interaction settings related to online, offline, and/or event directory visibility, incoming and outgoing communication preferences between host and/or other event users related to event or activity message type, frequency or notification preference, user settings for silencing, blocking, or alarming on incoming user requests and/o participation level based on activity, activity type, or activity or user characteristics. Additionally, event users can also configure the provisioned event activities that a user may want to participate or block.

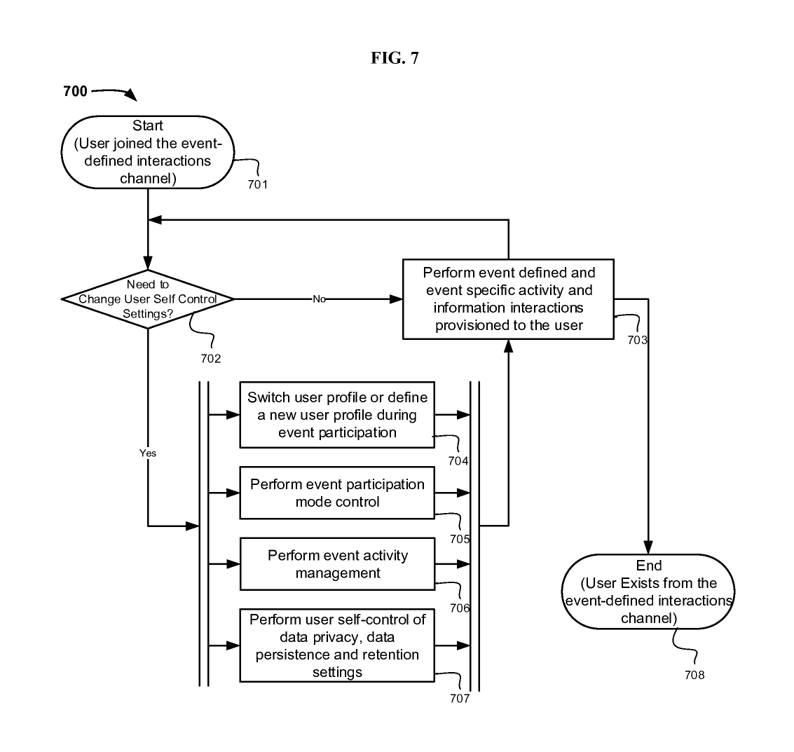

FIG. 7 is a flow chart showing an example of a process 700 that may be performed by an application user during an event participation with user-controlled data and user privacy settings. After a user joined in an event-defined interactions channel (block 701), the user can perform event defined and event specific activity and information interactions that are provisioned to the user (block 703), decide if there is a need to change event user self-control settings (block 702), or exit from the event-defined interactions channel (block 708).

In block 703, a user can perform event defined and event specific activity and information interactions that are provisioned to the user. These are event specific activities or information exchanges that are not related to user self-control activities. An event user can be interacting with information items about or related to the event, the event host, event activities, and the signed-in user to host and/or to other users posting or communication related activities that are provisioned to the sign-in user. Information interacting is the user actions performed by the signed-in user in viewing, responding to, creating, searching for, or browse information items related to the user interaction actions;

An event user can also interact with event defined and event specific activities that are provisioned to the event user such as browsing event user directory, sending outbound messages, requesting to meet, and etc. Event defined and specific activities are one or multiple functions, processes, actions, transactions, and/or communications the event user can interact with and/or invoke, which will result in one or multiple status or state changes and/or system responses.

If one or multiple event related information items are shareable, an event user can choose to share the information items via share and feed services outside of the event-defined interactions channel to a social network site, a website, a mobile app, or a media source.

Other common event activities or interactions that can be performed by an event user can be leaving event temporally, rejoining the event, or withdrawing from the event.

If an event user determined that he or she needs to change the event user self-control settings (block 702) during the event participation, the user can switch user profile or define a new user profile during event participation (block 704), perform event participation mode control (block 705), perform event activity management (block 706), and perform user self-control of data privacy, data persistence and retention settings (block 707).

In block 705 where a user performs event participation mode control, the event user can customize the user event participation and interaction preferences such as event defined activity and information interaction settings related to online, offline, and/or event directory visibility, incoming and outgoing communication preferences between host and/or other event users related to event or activity message type, frequency or notification preference, user settings for silencing, blocking, or alarming on incoming user requests and/o participation level based on activity, activity type, or activity or user characteristics.

In process block 706 where an event user can perform event activity management, the event user can browse or search for event activities that are provisioned for the user, select the activities to participate and the associated activity participation mode, or creating new activities if available and posting or inviting others.

In process block 707, an event user can perform user self-control of data privacy, data persistence and retention settings if determined necessary. During user event participation, an event user can change his or her current user setting for data privacy and data sharing setting for user generated data produced during event defined activity and information interactions. Data privacy and data sharing setting is related to specifications and controls for user generated data visibility and visibility levels, data collection and dissemination privileges and availability to the event host, other event users, and/or third party users. The data privacy and sharing setting can be configured to be associated and applied to the entire event lifecycle, one or multiple event lifecycle stages, an event activity, one or multiple event-defined activity or information interactions, or a user profile or profile switch action.

An event user can change current user setting for data persistence setting for user generated data produced during event defined activity and information interactions if determined necessary. Data persistence setting is specifications and controls for user generated data persistence location and saving or archiving privileges and availability to the event host, other event users, and/or third party users. Data persistence and/or data saving location is the server side and client-ends locations that the user generated data traverses, includes the computing device used by the event user for data generation, the event and interaction manager service server-side location that may process the user data, and the computing devices used by one or multiple correspondent event users. Data persistence setting can be configured associated with the entire event lifecycle, one or multiple event lifecycle stages, an event activity, one or multiple event-defined activity or information interactions, or a user profile or profile switch action.

An event user can also change current user setting for data retention setting for user generated data produced during event defined activity and information interactions. Event default data retention setting is specifications and controls for user generated data expiration settings for the persistence and/or cache locations that the user data may traverse so that the data will no longer be available at the specified locations according to data expiration settings. Data retention setting can be an absolute or relative duration value associated with the entire event lifecycle, one or multiple event lifecycle stages, an event activity, one or multiple event-defined activity or information interactions, or a user profile or profile switch action.

1. A system for event defined activity and information interaction channels between users and/or event host supporting user self-control of user profile selection or creation for event and/or event activity participation, user self-control of user data privacy, data sharing, data persistence, and retention settings, and user self-control of event participation mode and activity participation management, comprising:
A plurality of client-side computer application instances running on host and user computing devices for event-defined activity and information interactions definition and management by event host and for event sign-in and participation by the computer application users with user designated profiles or anonymously and assisted with user self-control of user data privacy, data sharing, data persistence, and retention settings, and user self-control of event participation mode and activity participation management, wherein host and user computing devices can be mobile devices such as smartphones or tablets, a personal computer such as a laptop or desktop, or any other computing machinery that has an operating system with applications supporting user interactions and calculation; and
One or multiple server-side event and interaction management application services for system-wide processing and support for event definition, control, management, and interfaces across all event-defined channels and the associated activity and communication interactions with the client-side application by the event hosts and participating users, wherein event and interaction management service is a computer application that can be implemented as public, community, hybrid, and/or on premise cloud services; and
Share and feed services for event host to push or pull event related information items defined in the said system from a social network site, a web site, a mobile app to support event definition and management, and for event users to push or pull event related information items to or from other social network sites, web sites, mobile apps, and/or email or message clients, wherein share and feed services can be APIs, interface services or other computer program implementations provided by the said system, social network sites, mobile apps, a third party service, and/or via email or messaging services; and/or
A plurality of social network sites, web sites, mobile apps, and/or email or messaging services with which event host can use to share or feed information during the event definition and management processes, and/or for event users to share event or event activity related information items if provisioned or authorized by the event host and the applicable event user data privacy and sharing setting for the related user-generated data; and/or
A plurality of other digital and/or physical media sources with information items or content that may not be able to utilize share and feed services for event definition related information items and can be referenced by the event-defined activity and information interaction channel; and/or
A plurality of other referable objects that can be people, locations, things, entities, establishment, needs, or social, business, or organizational activities that may not be able to utilize share and feed services for related information items and can be referenced by the event-defined activity and information interaction channel.

2. The system recited in claim 1, wherein an event is used to define and organize a singular and/or a collection of varied sequential and/or simultaneous activities and information items that has one or multiple purposes and/or produces one or multiple outcomes, and an event requires more than one person's participation and has a duration that can be repeating, short or long-running, and an event can be pertaining to one or multiple people, locations, things, entities, establishments, needs, social, business, or organizational activities, and/or content on digital or non-digital information or media sources, and an event can be linked to or occur within another event.

3. The system recited in claim 1, wherein an activity for an event-defined activity interactions is a collection of one or multiple functions, processes, actions, transactions, and/or communications accompanied by the related information items that an event user can interact with or invoke, which will result in one or multiple status or state changes and/or system responses, and an activity has a duration and can be defined with business logic, business rules, and/or user invocation requirements, and an activity can also be part of another activity or related to one or many other activities, provisioned and/or related to all the event users or a select group of event users based on user profile characteristics, user sign-in or sign-up controls or information, relationship to other activity or activities, and/or associated with the entire event or one or multiple event lifecycle stages.

4. The system recited in claim 1, wherein event and/or event activity participation includes all levels of an client-side application user's interest or interaction with an event such as passive or active following, viewing event information, sign-up, sign-in, sign-out, and/or interactions with an event or event activity with varied degrees of information exchanges with the event-defined channel and controlled by the user's participation mode setting.

5. The system recited in claim 1, wherein an event host maps to an event host role that defines and manages an event and event users, perform host event actions and other event administrative activities, wherein an event host can be a person, group of people, a business entity, an organization, or any other social, organizational, or legal entities, their designees or delegates.

6. The system recited in claim 1, wherein event users map to an event user role that participate in or follow an event and performs event defined activity and inform interactions, wherein an event user can be a person, group of people, a business entity, an organization, or any other social, organizational, or legal entities, their designees or delegates.

7. The system recited in claim 1, wherein the event has a lifecycle that may have one or multiple stages as predefined by an event template and/or determined by the event host, event progression status such as pre-event, event sign-up period, event in progress, or any other event progression period determined by the event characteristics.

8. The system recited in claim 1, wherein the server-side event and interaction management application services further comprises:
Event definition module for a host to define an event and/or invite users to participate that may support a host to quickly and easily create an event-defined interaction channel by clicking through a selected event template and filling in the required information, or a host can further custom define an event with fine grained controls and custom settings for additional event information items, activities, user participation mode, user data privacy and sharing, and/or user data persistence and retention settings, wherein an event may be defined via a blank event template or an predefined event template in the event template library that groups activities and/or information items for specific purpose and/or categorization, and the event may be defined by referencing one or multiple physical, mental, digital, social, or organizational objects, with or without share and feed services, servicing as a user-controlled interaction channel to one or multiple people, locations, organizations, entities, establishments, needs, one or multiple social, organizational, or business activities, or content on digital or non-digital information or media sources;
Event template library consisting of system predefined event templates for specific event purpose and/or categorization that can be applied and customized by an event host, wherein each event template is pre-configured with default event purpose and/or categorization related event specific activities, user self-control profile selection, definition, or switch activities, user self-control data privacy and data sharing setting activities, and user self-control participation mode setting activities; and the template is also pre-configured with default event purpose and/or categorization with event and event activity specific information items, and default information items supporting browse, search, and/or discovery services;
Event activity library consisting of system predefined activities that are common and reusable activities across different event types and/or categorizations, and each activity is associated with user self-controls for data privacy, data sharing, data persistence and retention settings, and/or participation mode settings;
Activity definition module for a host and/or users, if user activity definition is provisioned by the event host, to add an activity to a chose event template from the event activity library, modify an existing activity in the chosen event template, or define a new activity that is not available in the event activity library, wherein the activity can be modified or created with additional business logic, rules, and/or user invocation requirements;
Information definition and management for event and event activities related information items creation, management, and processing during event definition and event processing and execution phases;
Communication management for management of data or information items exchange, creation, and consumption by event host and event users during execution of an event;
Activity execution management for management of activities and activity lifecycles, and execution of activity related business logic, business rules and/or activity execution requirements pertaining to an event, host, and event users;
Event execution management that interoperates with communication management and activity execution management for event execution and event lifecycle management related to all the event-defined and related activity and information interactions between event users and/or host, including execution of related business rules, process definitions, user provisioning controls, and personalization logics for activities or information interactions for the event;
User management for event host to perform administration tasks for event users and event user interactions during execution of an event;
Data and user privacy management for management and execution of host and/or user defined user generated data and user privacy controls related to user profile selection or creation for event and/or event activity participation, user data privacy and data sharing, user data persistence and retention settings, and event participation mode and activity participation management, wherein an event user can configure more restrictive data and user privacy settings pertaining to user generated and user specific data than the settings defined or selected by the host for the event;
Integration module for connectivity and interfaces between the server-side event and interaction management application service modules, client-side computer application modules running on host and user computing devices, their associated functions, transactions, process handling, communications, and data and/or activities exchanges within the said system.

9. The system recited in claim 1, wherein the client-side computer application running on host and user computing devices further comprises:
Event discovery module that interfaces with the server-side event and interaction management service execution management module for a client-side application user to search, browse, and discover one or multiple events to participate with the associated user profile or anonymously, and with the associated user controlled participation mode and data settings;
Event participation module that interfaces with the event and interaction management application service for use by the event users to perform event and event activity participation at all levels as controlled by the event associated user self-control settings such as the associated participation mode setting and user data privacy, data sharing, data persistence, and data retention settings that are fulfilled by the user control module within the client-side computer application, wherein user self-control settings may be invoked from within an event for a user to configure or change the event specific user self-control settings, and the event participation levels and the associated participation mode may be related to an user's interest in passively or actively following or viewing the event or event activity information, and/or interest in sign-up, sign-in, sign-out, and/or interacting with an event or event activity with varied degrees of information exchanges;
User control module that is integrated with the server-side event and management application service for system wide user management and control executions for a client-side application user to perform user self-control of event and/or event activity profile selection or creation, user self-control of user data privacy and data sharing, user data persistence and retention settings, user self-control of event participation mode and event activity participation management, and/or perform user preference settings for default event and/or activity participation profile, default user data privacy and data sharing settings, default user data persistence and retention settings, default user participation mode setting, default display and notification settings for multiple events when participated at the same time, and/or to switch between user or host roles in case a user wants to create, host, and/or manage their own event, wherein user self-control data privacy and data sharing, data persistence and retention, and participation mode can override the host event settings for user generated data if the user settings have more restrictive data and user privacy controls; and user preferences settings for data privacy and data sharing, data persistence and retention can be associated with the client-side application as default for all the events a user may choose to participate, or the user preference data and user privacy settings can be associated with one or multiple user profiles defined by a user in the client-side application;
Event definition and management module that interfaces with the server-side event and management application service and serves as the user interface layer for the event and interaction management service for use by an event host to create event-defined and user controlled activity and information interactions channel that may reference one or multiple physical, mental, digital, social, or organizational objects, and the module is also used by an event host to manage users, perform host event actions and other event administrative activities;
Integration module for client-side application interactions and data exchanges with the server-side event and management application service interfaces, 3^{rd} party share and feed services inside a client-side computing device, and/or 3^{rd} party software, infrastructure or cloud services that might be related or applicable to an event-defined activities or information items.

10. The system recited in claim 9, wherein the client-side computer application and the application modules can be implemented as one integrated mobile app or separate mobile apps on iOS, Android or other types of smartphone or mobile devices, and/or with functionalities duplicated, consolidated, or spread across one or multiple new or existing mobile applications, and the application and the related modules can also be implemented as one or multiple new or existing web applications accessible via a web or mobile browser, one or multiple web browser add-ons or extensions, and/or one or multiple new or existing computer programs that can run on a user's computing device.

11. A method for creating an event-defined activity and information interaction channel by an event host supporting user self-control of user profile selection or creation for event and/or event activity participation, user self-control of user data privacy, data sharing, data persistence, and retention settings, and user self-control of event participation mode and activity participation management, comprising:
Determining whether the intended event-defined activities and/or information items can be referenced or related to content on existing digital information or media sources and can be pulled in or pushed over via share and feed services in the said system; wherein digital information or media sources are social network sites, web sites, mobile apps, or other digital media sources;
Upon determining that the intended event-defined activities and/or interaction items can be referenced or related to content on existing digital information or media sources and can be pulled in or pushed over via share and feed services, populating the event defined activities and information items via a selected event definition template with the event definition and management module in the client-side computer application, with share or feed of the related information items from the applicable digital information or media sources; and
Upon determining that the intended event-defined activities and/or interaction items cannot be referenced or related to content on existing digital information or media sources or cannot be pushed or pulled over via share and feed services, populating the event defined activities and information items directly in the said system via a selected event definition template with the event definition and management module in the client-side computer application, wherein the event-defined activities and information items can be in reference to one or multiple people, locations, services, entities, establishments, needs, one or multiple social, business, or organization activities, or content on digital or non-digital information or media sources; and
Creating an event id and/or the associated URI, barcode, QR code, or linkage references, wherein the event id is an alphanumeric string that can be manually entered by the event host or automatically generated via the client-side application for unique identification of the event;
Determining whether the event may have additional sign-in and/or sign-up requirements for users and/or for personalized event information items tailoring to a signed in or signed up user;
Upon determining that the event has additional sign-in and/or sign-up requirements, defining the sign-in and/or sign-up requirements for users with the associated information items, business logic, business rules, and/or personalization rules for personalized and targeted event information presentment in the event definition and management module via the client-side application;
Determining whether to customize the event template default event specific activities and the related information items;
Upon determining that the default event specific activities or information items may need to be customized, customizing template default event activities and event information items in the event definition and management module via the client-side application;
Determining whether to customize template default event participation mode and user generated data privacy settings, wherein user generated data privacy and user participation settings defined by the host can be overwritten by user self-control settings at sign-in and/or during event participation if the user settings impose more strict data and user privacy controls;
Upon determining need to customize template default event participation mode and user generated data settings, customizing event template default user participation mode and user generated data settings for user data privacy and data sharing, user data persistence and retention settings in the event definition and management module via the client-side application;
Determining whether to change event template default settings for event visibility for search, browse or discovery through association with location, topic, establishment, and/or other informational references;
Upon determining need for change event template default setting for event visibility, changing event default visibility for search, browse, and/or discovery through association with location, topic, establishment, and/or other informational references in the event definition and management module via the client-side application;
Determining whether to share, announce, or post event digitally or physically;
Upon determining need to share, announce, or post event digitally or physically, performing share, announce, or post of event via event id, URI, barcode, QR code, or reference links digitally to social or digital media, websites, mobile apps, email or messaging services, or physically to a physical location or a physical media.

12. The method recited in claim 11, wherein defining the sign-in and/or sign-up requirements for users with the associated information items, business logic, business rules, and/or personalization rules for personalized or targeted event information presentment further comprises:
Defining user sign-in and/or sign-up requirements and the associated information items, business logic, business rules with the event definition and management module via the client-side computer application; wherein sign-in and/or sign-up requirements are additional information, verification code, authentication or authorization information that an event user needs to enter to sign in or sign up for the event;
Determining whether to personalize event information items for personalized event information presentment to targeted event users;
Upon determining need to personalize event information to a signed-up or signed-in event user, defining event information personalization rules for personalized or targeted event information presentment, wherein information presentment personalization rules can be associated with the user provided sign-in or sign-up information, verification code, authentication or authorization information, or user profile characteristics.

13. The method recited in claim 11, wherein customizing template default event specific activities and the related information items further comprises:
Determining whether to add one or multiple activities to the event, wherein the intended activities to be added are not part of the selected event template default activities, and these intended activities may be optional event activities on the selected event template or may be only available from the event activity library module with the server-side event and interaction management application service;
Upon determining need to adding one or multiple activities, enabling optional activities on the selected event template if applicable and deemed necessary, or adding one or multiple activities from the server-side event and interaction manager application service activity library module with the associated information items;
Determining whether to remove one or multiple activities from the event template, wherein the activities to be removed are the event template default activities for the intended event-defined activity and information interaction channel;
Upon determining need to remove one or multiple activities from the event template, removing one or multiple activities from the selected event template with the event definition and management module via the client-side application;
Determining whether to modify one or multiple event template default activities and/or associated information items;
Upon determining need to modify one or multiple event template default activities, modifying one or multiple activities pre-defined in the selected event template and/or the associated information items with the event definition and management module via the client-side application;
Determining whether to define one or multiple new activities and add to the intended event-defined activity and information interaction channel, where in the new activities are the ones not available from the event activity library in the server-side event and interaction management application service;
Upon determining need to define one or multiple new activities, defining one or multiple new activities with the event definition and management module via the client-side application, which interfaces and invokes functions in the activity definition module with the server-side event and interaction management application service;
Determining whether to provision one or multiple activities in the event to a specific group of event users, wherein provisioning activities to event users is to define rules and conditions to allow event activity participation by certain users with or without the associated participation level;
Upon determining need to provision activities to specific group of event users, defining activity provisioning rules and conditions based on user profile information, user profile characteristics, or user provided sign-in or sign up information with the event definition and management module in the client-side application.

14. The method recited in claim 11, wherein determining customizing event template default user participation mode and user generated data settings for user data privacy and data sharing, user data persistence and retention settings further comprises:
Customizing event user default participation mode if deemed necessary, wherein participation mode is event defined activity and information interaction settings related to online and/or, offline visibility, event management visibility levels from zero to full user participation profile exposure, incoming and outgoing communication preferences between host and/or other event users in reference to the event, an activity in the event, event or activity associated message types, user profile, event and activity characteristics and/or lifecycle stages, and/or a select group of users, wherein communication preferences include message and/or message delivery frequency and/or timing, notification preferences, alerting or blocking mode for incoming user requests;
Customizing event default data privacy and data sharing setting, if deemed necessary, for user generated data produced during event defined activity and information interactions, wherein data privacy and data sharing setting is specifications and controls for user generated data visibility and visibility levels, data collection and dissemination privileges and availability to the event host, other event users, and/or third party users or organizations, and the data privacy and sharing setting can further be associated with the entire event lifecycle, one or multiple event lifecycle stages, an event activity, one or multiple event-defined activity or information interactions, or a user profile or profile switch action;
Customizing event default data persistence setting, if deemed necessary, for user generated data produced during event defined activity and information interactions, wherein data persistence setting is specifications and controls for user generated data persistence location and saving or archiving privileges and availability to the event host, other event users, and/or third party users or organizations, wherein data persistence location is the server side and user device client-side locations that the user generated data traverses, includes the computing device used by the event user for data generation, the event and interaction management service server-side location that may process the user data, and the computing devices used by one or multiple correspondent event users, and the data persistence setting can be associated with the entire event lifecycle, one or multiple event lifecycle stages, an event activity, one or multiple event-defined activity or information interactions, or a user profile or profile switch action;
Customizing event default data retention setting, if deemed necessary, for user generated data produced during event defined activity and information interactions, wherein event default data retention setting is specifications and controls for user generated data expiration settings for the persistence and/or cache locations that the user data may traverse so that the data will no longer be available at the specified locations according to data expiration settings, and the data retention setting can be an absolute or relative duration value associated with the entire event lifecycle, one or multiple event lifecycle stages, an event activity, one or multiple event-defined activity or information interactions, or a user profile or profile switch action.

15. The method recited in claim 11, changing event default visibility for search, browse, and/or discovery through association with location, topic, establishment, and/or other informational references further comprises:
Changing, if deemed necessary, event template default categories, types, keywords, tags, venue-related information, and/or other informational characteristics that can be used for browsing and searching;
Changing, if deemed necessary, event association with a location or location attributes, an entity or establishment, and/or a topic or information categorization for user discovery via location services or location attributes, interest in an entity or establishment, and/or interest in a topic or information categorization;
Changing, if deemed necessary, event template default or associated target user attributes, user profile characteristics, and/or user requirement attributes that can be mapped to user sign-in and/or sign-up information for more granular information item visibility control related to the event or one or multiple activities in the event.

16. A method for event defined activity and information interaction channel discovery and participation by a client-side computer application user, supporting user self-control of user profile selection or creation for event and/or event activity participation, user self-control of user data privacy, data sharing, data persistence, and retention settings, and user self-control of event participation mode and activity participation management, comprising:
Determining an event to join upon notification or via search, browse, discovery through event association with event related information items, location, topic, or establishment, or other informational references from an information or media source;
Upon determining need to join an event, pulling in the event via the client-side computer application, wherein pulling in the event is the first step in event participation before if any sign-up or sign-in required for the event, with which the pulled in event can be associated with a user anonymously or with a user selected user profile, and/or associated with a user participation mode with different levels such as follow, view only, view and notification, and/or interacting configured with the user control module in the client-side application;
Providing sign up information if required and/or if the event is not in progress, wherein sign up information is additional information, verification code, authentication requirements, or authorization information that may be used by the event to determine a user's eligibility to view certain type of information and/or participate in certain type of activities;
Viewing additional event information related to user sign-up information if applicable and/or available, wherein the applicable sign-up related event information are additional information items related to the event or event activities that may be presented to all the signed up users and/or personalized and targeted to a user sign-up information;
Signing into the event if the event is already in-progress by selecting an existing user profile, defining a new user profile, or signing in anonymously;
Providing additional sign-in information if required, wherein additional sign-in information may be related to a generic or user-specific verification code, authentication or authorization information, or any other information pertaining to the event and/or the signing in user;
Viewing additional event information related to user provided sign-in information if applicable and/or available, wherein the applicable sign-in related event information are additional information items related to the event or event activities that may be eligible and presented to all or a portion of the signed in users, and/or the information or event activities may be personalized and targeted to a user sign-in information;
Determining whether to customize event default and event user self-control settings for at the event pull-in, sign-up or sign-in time;
Upon determining need to customize event user self-control settings at the event pull-in, sign-in or sign-up, performing user self-control of user data privacy, data sharing, data persistence, and retention settings, and user self-control of event participation mode and activity participation management with the user control module via the client-side application;
Performing event defined and event specific activity and information interactions provisioned to the signed-in user;
Determining whether to use a different user profile for one or multiple event activities or information interactions during event participation, wherein the intended user profile can be associated with one or multiple activities, one or multiple event lifecycle stages as configured via the event creation process, and/or one or multiple activity or information interactions;
Upon determining need to use a different user profile, selecting an existing user profile or creating a new user profile for the intended activity or information interactions with the functions provided by the user control module via the client-side application;
Determining whether to customize the current user event participation mode for one or multiple event activities or information interactions during event participation, wherein the intended participation model setting can be associated with one or multiple activities, one or multiple event lifecycle stages as configured via the event creation process, and/or one or multiple activity or information interactions;
Upon determining need to customize current user event participation mode, configuring user participation mode and applying for the signed-in event and/or activities with the functions provided by the user control module via the client-side application;
Determining whether to perform event activity participation management during event participation, wherein user event activity participation management is user control of whether to or not to participate the event activities provisioned to the signed-in event user;
Upon determining need to perform event activity management, selecting, from the list of the activities provisioned to the signed-in user, the activities to participate or block and the associated activity participation mode with the functions provided by the user control module via the client-side application;
Determining whether to change the current settings for user data privacy, data sharing, data persistence, or data retention for the data generated by the user during event defined activity and information interactions;
Upon determining need to change current settings for use data privacy, data sharing, data persistence or data retention, performing user self-control of data privacy, data sharing, data persistence, or data retention settings with the functions provided by the user control module via the client-side application.

17. The method recited in claim 16, wherein pulling in the event via the client-side application further comprises:
Entering an event id directly in the event app to pull in the event into the application if the event id is available and deemed necessary;
Scanning an event associated barcode or QR code to pull the event into the application if applicable, wherein the event bar or QR code can be posted on a social network or web site or their associated mobile app, included in an email or message via an email or messaging service, on a sticker or posted at a physical location;
Pressing or acting on a URI or reference link associated with the event that may bring up the event in the client-side application if applicable, wherein the URI or reference link can be on a social media site, website, inside a mobile app, included in an email or message, or from a traditional media;
Acting on one or multiple events discovered via the event discovery module with the client-side application by dragging in or following the menu action items associated with the discovered event for event participation, wherein an event to participate may be discovered via search, browse, or discovery via location, topic, or establishment aware services.

18. The method recited in claim 16, wherein performing user self-control of user data privacy, data sharing, data persistence, and retention settings, and user self-control of event participation mode and activity participation management with the user control module via the client-side application at the event pull-in, sign-up, or sign-up further comprises:
Determining whether to change the event default data and user privacy settings and apply user pre-defined preference settings for data and user privacy to the event the user decide to participate, wherein user pre-defined preference settings for data and user privacy can be at the user level across all the events a user may choose to participate, or it can be associated with one or multiple user profiles, and/or associated with one or multiple event or event activity categories or characteristics;
Upon determining need to apply user pre-defined preference setting for data and user privacy, associating the selected user pre-defined preference setting for data and user privacy to the participated event with the functions provided by the user control module via the client-side application;
Determining whether to change event default and/or user participation profile default data sharing, data persistence, or data retention settings for user generated data produced during event defined activity and information interactions, wherein user participation profile default or user customized data sharing, data persistence, or data retention settings, if available or applicable, will take precedence over the event default settings if the settings are more restrictive;
Upon determining need to change event and/or user participation profile default and data sharing, data persistence, or data retention settings for user generated data for the participating event or event activity, changing and applying the desired data sharing, data persistence, and/or data retention settings to the corresponding event and/or event activity with the functions provided by the user control module via the client-side application;
Determining whether to change event default and/or event participating user profile default participation mode, wherein event participating user profile default or user customized participation mode, if available or applicable, will take precedence if the participation mode is more strict than the event default user participation mode;
Upon determining need to change event and/or event participating user default participation mode, configuring event and/or activity participation mode and applying to the event or event activity with the functions provided by the user control module via the client-side application.

19. The method recited in claim 16, wherein performing event defined and event specific activity and information interactions provisioned to the signed-in user further comprises:
Interacting with information items about or related to the event and/or the event references, the information items related or about the event host, event activities, and/or related other event participating user postings or communications that are visible and/or provisioned to the sign-in user, wherein interacting with information items is the user actions performed by the a signed-in event user such as viewing, messaging, responding, copying, and other information processing or communication actions with the event-defined channel;
Interacting with event defined and event specific activities that are provisioned to the event user, wherein event defined and specific activities are one or multiple functions, processes, actions, transactions, and/or communications the event user can interact with and/or invoke, which will result in one or multiple status or state changes and/or system actions;
Determining whether one or multiple information items can be shared outside the event and if the event user intends to share the information outside of the event, wherein the shareable information items are defined by the event host and/or users who creates or generates the specific information items;
Upon determining that the information items are shareable, share the information items via share and feed function and services in the said system to a social network site, a website, a mobile app, or a media source;
Determining whether to stop participating an event and discarding the event, wherein stop participating and discarding an event means signing out of an event permanently with a user-generated data archived or erased to the degree as specified by the user controlled settings for data privacy, persistence, and retention;
Upon determining need to stop participating an event, signing off permanently from the event with the user self-controlled data privacy, persistence, and retention settings.

20. The method recited in claim 16, wherein performing user self-control of data privacy, data sharing, data persistence, or data retention settings during event participation further comprises:
Changing the current user setting for data privacy and data sharing setting, if deemed necessary, for user generated data produced during event defined activity and information interactions;
Changing the current user setting for data persistence setting, if deemed necessary, for user generated data produced during event defined activity and information interactions;
Changing the current user setting for data retention setting, if deemed necessary, for user generated data produced during event defined activity and information interactions.
